(19) United States
(12) Patent Application Publication
(10) Pub. No.: US 2022/0125087 A1
(43) Pub. Date: Apr. 28, 2022

(54) System and Method for Producing Synthetic Water Flavor Profile Concentrates

(71) Applicant: William Goff, Waynesville, NC (US)

(72) Inventor: William Goff, Waynesville, NC (US)

(21) Appl. No.: 17/077,363

(22) Filed: Oct. 22, 2020

(51) Int. Cl. A23L 29/00; A23L 27/00; A23L 5/30

(52) U.S. Cl. CPC A23L 29/015; A23L 5/30; A23L 27/82; A23L 27/88

(57) ABSTRACT

The present invention is a system and method for calculating the differences in chemical and/or mineral constituencies present in the makeups of a source water profile and a target water profile and calculating an optimized routine for altering the source water profile to mimic the target water profile. The present innovation utilizes an optimization function to determine the constituent differences and to derive a dosing routine to mix one or more batches of output mixture. The present innovation employs a dosing machine to affect the routine determined by the optimization function. In an embodiment the dosing machine utilizes one or more ingredient-dedicated peristaltic pumps to mix ingredients into one or more output mixture batches and deliver the one or more output mixture batches to a human user.

### COPYRIGHT NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever.

### BACKGROUND

As ground water percolates through a region's soil, it takes on a flavor profile unique to the region of the globe in which it is harvested. Water thus harvested lends its unique regional flavor profile to consumables, such as beverages or bread, with which the water is made. For instance, a Bavarian beer made with Bavarian ingredients reflects true Bavarian taste only by being brewed with water characterized by a Bavarian water profile. The water profile is, at least in part, in part a function of the type and quantity of dissolved minerals present in the water itself. Brewers, bakers, or other makers of consumables intended to evoke regional flavors typically control for non-water flavor-constituents to impact the taste of any resulting consumable.

### BRIEF DESCRIPTION OF THE DRAWINGS

Certain illustrative embodiments illustrating organization and method of operation, together with objects and advantages may be best understood by reference to the detailed description that follows taken in conjunction with the accompanying drawings in which:

FIG. 1 is a view of a sub-process for returning an optimized ingredient dosing routine consistent with certain embodiments of the present invention.

FIG. 2 is a view of a sub-process for producing an output mixture based upon an optimized routine consistent with certain embodiments of the present invention.

FIG. 3 is a view of a first machine apparatus consistent with certain embodiments of the present invention.

FIG. 4 is a view of a second machine apparatus consistent with certain embodiments of the present invention.

FIG. 5 is a view of a container-component of a second machine apparatus consistent with certain embodiments of the present invention.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language).

Reference throughout this document to “one embodiment”, “certain embodiments”, “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

Unless specifically stated otherwise as apparent from the following discussion, it is appreciated that throughout the description, discussions utilizing terms such as “processing” or “computing” or “calculating” or “deter g” or “displaying” or “analyzing” or the like, refer to the action and processes of a computer system, or similar electronic computing device (such as a specific computing machine), that manipulates and transforms data represented as physical (electronic) quantities within the computer system memories or registers or other such information storage, transmission or display devices.

Certain aspects of the embodiments include process steps and instructions described herein. It should be noted that the process steps and instructions of the embodiments can be embodied in software, firmware or hardware, and when embodied in software, could be downloaded to reside on and be operated from different platforms used by a variety of operating systems. The embodiments can also be in a computer program product which can be executed on a computing system.

The embodiments also relate to an apparatus for performing the operations herein. This apparatus may be specially constructed for the purposes, e.g., a specific computer, or it may comprise a computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Memory can include any of the above and/or other devices that can store information/data/programs and can be transient or non-transient medium, where a non-transient or non-transitory medium can include memory/storage that stores information for more than a minimal duration. Furthermore, the computers referred to in the specification may include a single processor or may be architectures employing multiple processor designs for increased computing capability.

The processes and displays presented herein are not inherently related to any particular computer or other apparatus. Various systems may also be used with programs in accordance with the teachings herein, or it may prove convenient to construct more specialized apparatus to perform the method steps. The structure for a variety of these systems will appear from the description herein. In addition, the embodiments are not described with reference to any particular programming language. It will be appreciated that a variety of programming languages may be used to implement the teachings of the embodiments as described herein, and any references herein to specific languages are provided for disclosure of enablement and best mode.

Although the flavor profiles of many consumables can be approximated by controlling for non-water flavor-constituents in the consumable (such as, by way of non-limiting example, brewed beverages and/or breads), without controlling for water composition, the end result is invariably an inexact flavor match. Because water as a product constituent is tremendously dense and therefore difficult and expensive to transport, it is desirable that water flavor profile concentrates capable of being diluted are made available to creators of such consumables. Thus, there is a need for a system and method for producing brew-ready all-natural and/or synthetic water flavor profile concentrates.

In an embodiment, the present innovation incorporates a machine composed at least of one or more containers of distilled water and one or more containers of water containing dissolved mineral solids. In a preferred embodiment, each container is a bottle with a conical bottom fitted with sanitary tri-clover style fittings, and having a wide opening, typically at the top, for adding water and minerals to the bottle. The contents of each bottle represent a single-mineral homogenous solution and/or suspension. In an embodiment, the instant innovation utilizes one or more peristaltic pumps to recirculate each solution and/or suspension to maintain fluid homogeneity within each bottle. Each peristaltic pump may be connected to the side of each bottle, permitting dosing even during active recirculation. Each peristaltic pump is used to both mix the contents of each bottle and to convey the bottle contents to a manifold for combination with measured and specific contents of other bottles. All bottles together form an array of containers from which the resulting fluid combination is drawn.

In an embodiment, the output of each bottle's peristaltic pump is directed to a gravity-fed manifold with one or more solenoid-adjustable intake valves. The manifold is typically located beneath an array of the bottles. The intake valves may be opened and closed via the valves' associated solenoid to permit introduction of exact amounts of input solution and/or suspension, and prevent accidental introduction of unwanted amounts of the same solution and/or suspension. The manifold serves as a gateway to a gravity-fed mixing vessel typically located beneath the manifold.

In an embodiment the instant innovation pumps, from a reservoir, water processed by reverse osmosis into the manifold to top off the mixing vessel. With the mixing vessel removed or replaced by a discard vessel, the instant innovation pumps water processed by reverse osmosis into the manifold to purge the manifold of residual minerals. The instant innovation utilizes one or more bursts of compressed air to purge the manifold of any residual water. In an embodiment the instant innovation utilizes flow meters to more exactly quantify water flow volume.

In an embodiment, the apparatus incorporates one or more automated conveyor systems to convey one or more mixing vessels and/or discard vessels into and out of place beneath the system manifold.

In an embodiment, any water source can be characterized by a “water profile.” As used herein, a “water profile” is defined as the unique combination of mineral constituents and/or chemical constituents in ground water or water from a municipal water source from a particular geographical location. Frequently this combination is expressed as parts-per-million. Many governmental bodies provide access to water profiles from municipal water sources within those bodies' jurisdictions. Any particular water profile can have a direct bearing on human perception of taste of the water so profiled. In an embodiment, any target water profile may be determined through laboratory analysis.

In an embodiment, the instant innovation utilizes a digital system interface to permit a human controller to specify a desired system output of a particular water profile. Desired system output includes indicia regarding parts-per-million of dissolved and/or suspended mineral solids in liquid water to create an output water solution having a profile matching the desired system output. System output may include total output volume and/or output speed.

In an embodiment, the human controller interacts with the digital system via one or more touch-sensitive screens. Once the controller has input desired specifications for a pre-configured desired system output, the instant innovation runs a computer-controlled optimizer function as a part of the system algorithm. The instant innovation then controls a relay board, thereby operating the proper peristaltic pumps for an appropriate time interval as specified by the optimizer function.

In an embodiment, the water profile is entered into a computer associated with the machine of the instant innovation. By way of non-limiting example, water profile entry is accomplished via a graphical user interface on the machine, or via populated cells on a calculator spreadsheet, or from a profile communicated from a computer, server, smartphone, or mobile device in networked data communication with the machine. The computer associated with the apparatus stores the water profile for future reference.

In an embodiment, the instant innovation provides specified doses of chemicals to affect the amounts of at least two target minerals in the machine output. The instant innovation utilizes an optimization function of a system algorithm to test thousands of dosing options to determine the optimum volume of each chemical dose required to produce an approximate target water profile as closely as possible. In an embodiment, the algorithm is capable of returning a target water profile with an average variance of no more than approximately 2.13% from the target water profile. The output of the machine of the instant innovation is a concentrate, which may then be diluted with water produced by reverse osmosis to deliver water reflecting the approximate target water profile. In an embodiment, random samples of the system output may be tested to verify accuracy.

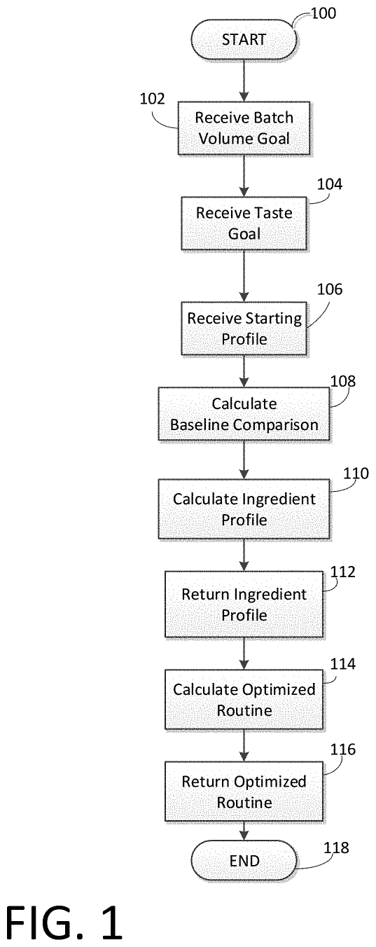

Turning now to FIG. 1, a view of a sub-process for returning an optimized ingredient dosing routine consistent with certain embodiments of the present invention is shown. At 100, the sub-process starts. At 102 the instant innovation receives a metric for the ending volume goal of the output mixture. At 104 the instant innovation receives a metric for a taste goal, such taste goal characterizing the flavor and/or other sensory-perceivable characteristics of the prospective output mixture. At 106 the instant innovation receives a starting profile for the originating medium, where the starting profile is a metric describing the chemical and/or mineral constituent makeup of the originating medium. In an embodiment, the originating medium is the water to be altered to produce the prospective output mixture. At 108 the instant innovation calculates a baseline comparison between the chemical and/or mineral constituents of the originating medium and the desired chemical and/or mineral constituents of the prospective output mixture. By way of non-limiting example, chemical and/or mineral constituents can include calcium sulfate, sodium chloride, magnesium sulfate, calcium carbonate, and/or sodium bicarbonate. At 100 the instant innovation calculates the ingredient profile necessary to add to the originating medium to alter the originating medium to achieve the prospective output mixture. At 112 the instant innovation returns the calculated ingredient profile, and at 114 the instant innovation calculates the optimized dosing and mixing routine to most efficiently produce the prospective output mixture. At 116 the instant innovation returns the optimized routine. At 118 the sub-process ends.

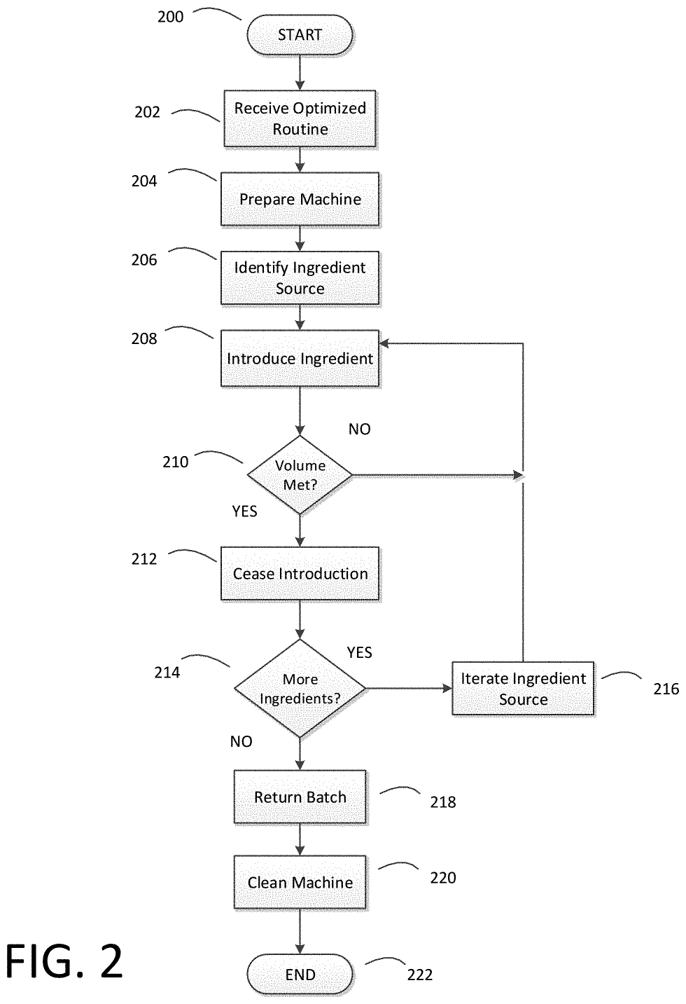

Turning now to FIG. 2, a view of a sub-process for producing an output mixture based upon an optimized routine consistent with certain embodiments of the present invention is shown. At 200 the sub-process starts. At 202 the instant innovation receives the optimized routine developed as described in FIG. 1. At 204 a human operator or a robot prepares the mixing machine for operation. At 206 the instant innovation uses the received optimized routine to identify the first chemical and/or mineral source, the source in a non-limiting embodiment being a bottle or bag identified by the machine as containing the first chemical and/or mineral ingredient. At 208 the instant innovation introduces the first chemical and/or mineral ingredient. By way of non-limiting example, this introduction may be by operation of an ingredient-dedicated peristaltic pump's pumping ingredient into a mixing vessel. If at 210 the introduced ingredient volume is not met, the instant innovation continues to introduce the ingredient at 208. If at 210 the introduced ingredient volume is met, then at 214 the instant innovation determines whether the optimized routine calls for the introduction of additional ingredients. If at 214 the instant innovation determines that the optimized routine calls for the introduction of an additional ingredient, the instant innovation iterates the ingredient source at 216. In a non-limiting example, this iteration is affected by activating a peristaltic pump uniquely paired with a container holding an ingredient different from the already introduced ingredient or ingredients. At 208 the instant innovation introduces the newly-called-for ingredient until at 210 the instant innovation determines that the volume of the new ingredient is met, whereupon it ceases introduction of the ingredient at 212. If at 214 the instant innovation determines that the optimized routine calls for no additional ingredients, then at 218 the instant innovation returns a batch of output mixture. At 220, a human operator or robot cleans the machine in preparation for the creation of a new batch of output mixture. At 222 the sub-process ends.

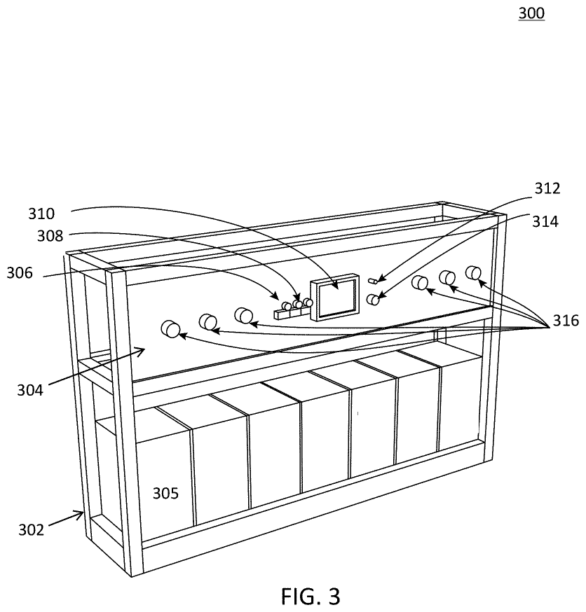

Turning now to FIG. 3, a view of a first machine apparatus consistent with certain embodiments of the present invention is shown. The first machine apparatus 300 is composed of at least a frame-like structure 302 having an upper and a lower section. The upper section of frame-like structure 302 frames a control panel 304. In an embodiment, control panel 304 has as components a main power switch 306, a recirculation switch 308, a user-interface touch screen 310, a rotary encoder switch 312, an emergency stop button 314, and peristaltic pumps at 316. The bottom section of frame-like structure 302 frames a series of vessels 305. In an embodiment where the series of vessels 305 is composed of seven individual vessels, each of six of the vessels may contain an individual, discrete, homogeneous mineral and/or chemical solution to be mixed according to the algorithm of the present innovation. The seventh vessel may be a collection vessel, into which the optimized combined outputs of the other six vessels may be mixed to form a final output solution.

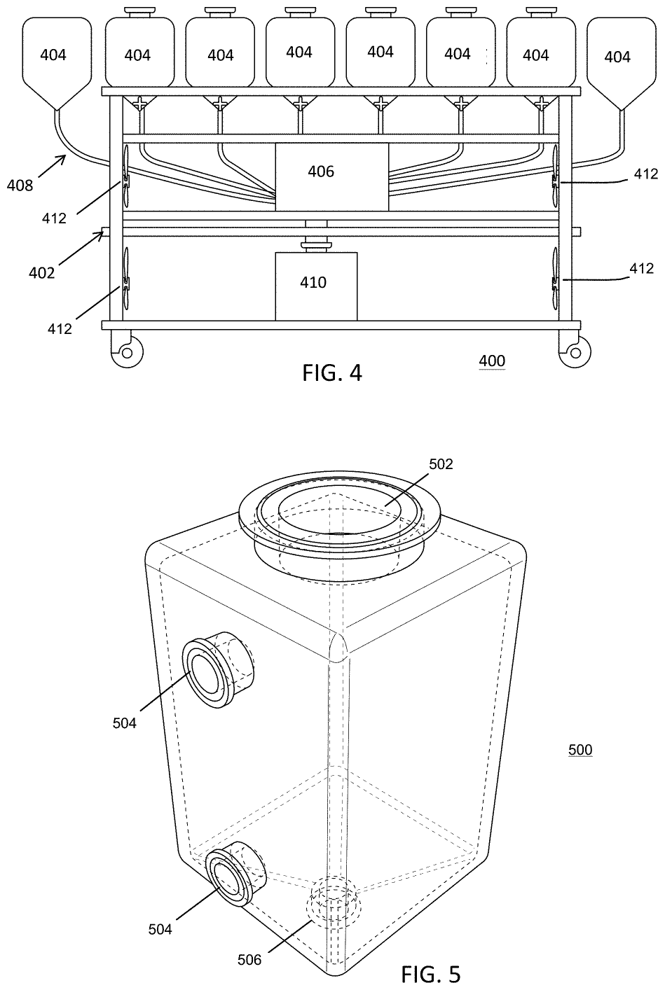

Turning now to FIG. 4, a view of a second machine apparatus consistent with certain embodiments of the present invention is shown. The second machine apparatus 400 is composed of at least a frame-like structure 402 having an upper, middle, and lower section. The upper section of frame-like structure 402 holds a series of vessels 404 containing constituent ingredients to be mixed in accordance with the algorithm of the present innovation. In an embodiment where the series of vessels 404 numbers eight arranged in a row, each of the six vessels in the center of the row may contain an individual, discrete, homogeneous mineral and/or chemical solution to be mixed according to the algorithm of the present innovation. Each of the seventh and eighth vessels at either end of the row of vessels may contain water processed by reverse osmosis, such water to be mixed with the mineral and/or chemical solution forming the machine output. The middle section of frame-like structure 402 holds a control panel 406 which receives user input regarding the desired output. The control panel 406 receives ingredients from the series of vessels 404 via a series of fluid channels 408. The lower section of frame-like structure 402 holds a collection vessel 410 into which the output mixture is discharged. Each of the middle and lower sections of frame-like structure 402 houses one or more fans 412. Fans 412 are operative to alter or maintain the temperature within frame-like structure 412 when ambient temperature is greater than one or more pre-configured values. These one or more pre-configured values can change at least in part based on the algorithm of the present innovation.

Turning now to FIG. 5, a view of a container-component of a second machine apparatus consistent with certain embodiments of the present invention is shown. In an embodiment, the container 500 is generally a hollow rectangular prism, the center void of which is capable of holding fluid component of the present innovation. Container 500 has a top opening 502 for the addition of water and additives, and a bottom opening 506 for the output of the constituent fluid concentration resident in the bottle. The bottom of the bottle is roughly an inverted pyramid shape. Bottom opening 506 is set at the center of the bottom of the bottle, at the apex of the inverted pyramid shape. Container 500 has protrusion openings 504 for connection to a peristaltic pump. The peristatic pump (not shown) utilizes one protrusion opening for input to the container 500 and one protrusion opening for output from the container.

While certain illustrative embodiments have been described, it is evident that many alternatives, modifications, permutations and variations will become apparent to those skilled in the art in light of the foregoing description.

I claim:

1. A system for producing water flavor profile concentrates, comprising:
a server with a processor in communication with a mixing apparatus;
collecting a target water profile for a prospective output mixture;
collecting a starting water profile characteristic of a baseline input water profile for system input;
calculating the dissolved and/or suspended chemical and/or mineral differences between the target water profile and the baseline water profile;
calculating an optimized routine for the introduction into the baseline input water profile of the one or more dissolved and/or suspended chemicals and/or minerals to produce an output mixture conforming to the target water profile;
the dosing machine mixing the one or more dissolved and/or suspended chemical and/or minerals into a pre-measured quantity of water having the baseline input water profile; and
returning an output mixture to a human user than conforms to the target water profile.

2. The system according to claim 1, where the target water profile is a flavor profile capable of being perceived by human senses.

3. The system according to claim 2 where a flavor profile is a function of at least one or more dissolved and/or suspended chemical and/or mineral water constituents.

4. The system according to claim 1, where the one or more dissolved and/or suspended chemicals and/or minerals includes calcium sulfate and/or sodium chloride and/or magnesium sulfate and/or calcium carbonate and/or sodium bicarbonate.

5. The system according to claim 1, where the mixing apparatus uses one or more peristaltic pumps to mix chemical and/or mineral ingredients.

6. The system according to claim 1, where all calculations are performed by an optimization function resident upon the server with a processor.

7. A method for producing water flavor profile concentrates, comprising:
initiating communication between a server with a processor and a mixing machine;
collecting a target water profile for a prospective output mixture;
collecting a starting water profile characteristic of a baseline input water profile for system input;
calculating the dissolved and/or suspended chemical and/or mineral differences between the target water profile and the starting water profile;
calculating an optimized routine for the introduction into the starting medium of the one or more dissolved and/or suspended chemicals and/or minerals to produce an output mixture conforming to the target water profile;
activating the mixing apparatus to mix the one or more dissolved and/or suspended chemical and/or minerals into a pre-measured quantity of water having the baseline input water profile; and
returning an output mixture to a human user than conforms to the target water profile.

8. The method according to claim 7, where the target water profile is a flavor profile capable of being perceived by human senses.

9. The method according to claim 8 where the flavor profile is a function of at least one or more dissolved and/or suspended chemical and/or mineral water constituents.

10. The method according to claim 7, where the one or more dissolved and/or suspended chemicals and/or minerals includes calcium sulfate and/or sodium chloride and/or magnesium sulfate and/or calcium carbonate and/or sodium bicarbonate.

11. The method according to claim 7, where the mixing apparatus uses one or more peristaltic pumps to mix chemical and/or mineral ingredients.

12. The system according to claim 7, where all calculations are performed by an optimization function resident upon the server with a processor.
